(19) United States
(12) Patent Application Publication
(10) Pub. No.: US 2025/0371627 A1
(43) Pub. Date: Dec. 4, 2025

(54) METHOD, APPARATUS, DEVICE AND STORAGE MEDIUM FOR INTERFACE INTERACTION

(71) Applicant: Beijing Zitiao Network Technology Co., Ltd., Beijing (CN)

(72) Inventors: Quan YANG, Beijing (CN); Liang XIA, Beijing (CN); Xiaoshuang BAI, Beijing (CN); Hang QIU, Beijing (CN)

(21) Appl. No.: 18/875,060

(22) PCT Filed: Jun. 13, 2023
(86) PCT No.: PCT/CN2023/099968

§ 371 Date: Dec. 13, 2024

(30) Foreign Application Priority Data
Jun. 14, 2022 (CN) 202210674692.2

(51) Int. Cl. G06Q 50/00

(52) U.S. Cl. CPC G06Q 50/01

(57) ABSTRACT

The embodiments of the disclosure provide a method, an apparatus, a device and storage medium for interface interaction. The method includes, in response to detecting an indication of adding media content while a first post interface is displayed, displaying a second content interface for selecting a media content, the first post interface presenting at least one first media content that has been selected to be posted, the at least one first media content being in an unselected state in the second content interface; and in response to receiving a selection of at least one second media content in the second content interface, displaying a second edit interface for editing a selected media content, the second edit interface providing an editing function for the at least one first media content and the at least one second media content.

### CROSS-REFERENCE

This application is a National Phase entry of International Application No. PCT/CN2023/099968, filed on Jun. 13, 2023, and entitled “METHOD and APPARATUS FOR PAGE INTERACTION, DEVICE, AND STORAGE MEDIUM”, which claims priority to Chinese patent application No. CN202210674692.2, filed on Jun. 14, 2022 and entitled “METHOD, APPARATUS, DEVICE AND STORAGE MEDIUM FOR INTERFACE INTERACTION”, which is incorporated herein by reference in its entirety.

### FIELD

Example embodiments of the present disclosure generally relate to the field of computers, and in particular, to a method, an apparatus, a device, and computer-readable storage media for interface interaction.

### BACKGROUND

Currently more and more applications are being designed to provide various services to users. Users can perform various operations on the applications. For example, users can post various types of media content, such as images, videos, audios, etc., in content sharing applications. During the process of releasing the media content, the user can perform various operations such as media content selection, media content editing, media content re-selection, etc. in different interfaces of the application. Therefore, convenient switching between these interfaces is important.

### SUMMARY

In a first aspect of the present disclosure, a method of interface interaction is provided. The method includes, in response to detecting an indication of adding media content while a first post interface is displayed, displaying a second content interface for selecting a media content, the first post interface presenting at least one first media content that has been selected to be posted, the at least one first media content being in an unselected state in the second content interface. The method further includes, in response to receiving a selection of at least one second media content in the second content interface, displaying a second edit interface for editing a selected media content, the second edit interface providing an editing function for the at least one first media content and the at least one second media content.

In a second aspect of the present disclosure, an apparatus for interface interaction is provided. The device comprises a content interface display module configured to, in response to detecting an indication of adding media content while a first post interface is displayed, display a second content interface for selecting a media content, the first post interface presenting at least one first media content that has been selected to be posted, the at least one first media content being in an unselected state in the second content interface. The apparatus further includes an edit interface display module configured to, in response to receiving a selection of at least one second media content in the second content interface, display a second edit interface for editing a selected media content, the second edit interface providing an editing function for the at least one first media content and the at least one second media content.

In a third aspect of the present disclosure, an electronic device is provided. The apparatus includes at least one processing unit; and at least one memory coupled to the at least one processing unit and storing instructions for execution by the at least one processing unit, the instructions, when executed by the at least one processing unit, cause the electronic device to perform the method of the first aspect.

In a fourth aspect of the present disclosure, a computer-readable storage medium is provided. The computer-readable storage medium has a computer program stored thereon, the computer program being executable by a processor to implement the method of the first aspect.

It should be understood that the content described in the content part of the present disclosure is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, wherein:

FIG. 1 illustrates a schematic diagram of an example environment in which embodiments of the present disclosure can be implemented;

FIG. 2 illustrates a flowchart of a process for interface interaction according to some embodiments of the present disclosure;

FIG. 3A illustrates a schematic diagram of an example interface change of an added media content according to some embodiments of the present disclosure;

FIG. 3B illustrates a schematic diagram of an example interface change of falling back from a second post interface according to some embodiments of the present disclosure;

FIG. 3C illustrates a schematic diagram of an example interface change of falling back from a second edit interface according to some embodiments of the present disclosure;

FIG. 4 illustrates a schematic diagram of a forward flow of media content post according to some embodiments of the present disclosure;

FIG. 5 illustrates a schematic diagram of a return flow of media content post according to some embodiments of the present disclosure;

FIG. 6 illustrates a block diagram of an apparatus for interface interaction according to some embodiments of the present disclosure; and

FIG. 7 illustrates a block diagram of a device capable of implementing various embodiments of the present disclosure.

### DETAILED DESCRIPTION

Embodiments of the present disclosure will be described in more detail below with reference to the accompanying drawings. While certain embodiments of the present disclosure are shown in the accompanying drawings, it should be understood that the present disclosure may be implemented in various forms and should not be construed as limited to the embodiments set forth herein. Rather, these embodiments are provided for a more thorough and complete understanding of the present disclosure. It should be understood that the drawings and embodiments of the present disclosure are for example purposes only and are not intended to limit the scope of the present disclosure.

In the description of the embodiments of the present disclosure, the terms “including”, and the like should be understood to include “including but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definition may also be included below.

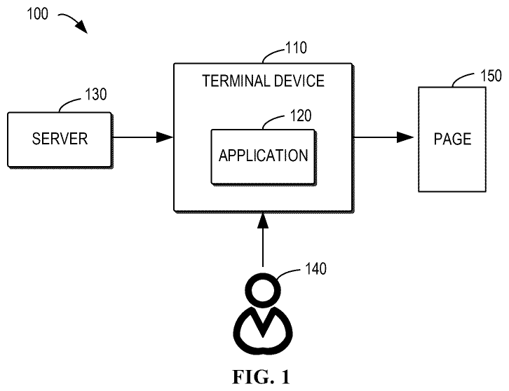

FIG. 1 illustrates a schematic diagram of an example environment 100 in which embodiments of the present disclosure can be implemented. In this example environment 100, an application 120 is installed in a terminal device 110. A user 140 may interact with the application 120 via the terminal device 110 and/or an attachment device of the terminal device 110. The application 120 may be a content sharing application capable of providing at least the user 140 with services related to media content consumption, including selection, editing, releasing, and the like of media content. In this specification, “media content” may include a variety of forms including, but not limited to, images (such as photographs taken, synthesized pictures, screenshots), videos, audios, and the like. In some embodiments, the application 120 may also provide other services related to media content consumption, such as browsing, commenting, forwarding, creating (e.g., taking and/or editing) of media content, and the like.

During the media content post process, the terminal device 110 may present a interface 150 of the application 120 to the user 140 for the user 140 to perform various operations. The interface 150 may include a interface (also referred to as a content interface) for selecting media content to be posted, a interface (also referred to as an edit interface) for editing the selected media content, a interface (also referred to as a post interface) for presenting the media content to be posted, and so on.

The terminal device 110 may be any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the terminal device 110 can also support any type of interface for a user (such as a “wearable” circuit, etc.).

In some embodiments, the terminal device 110 communicates with a server 130 to implement provisioning of services to the application 120. The server 130 is various types of computing systems/servers capable of providing computing power, including, but not limited to, mainframes, edge computing nodes, computing devices in a cloud environment, and the like.

It should be understood that the structure and function of the environment 100 is described for example purposes only and does not imply any limitation to the scope of the present disclosure.

Taking an image as an example, in a post process, a user has a requirement to increase an image to be posted. For example, the user may increase the image when the post interface is displayed. In general, images that have been selected to be posted cannot be repeatedly selected, however in some scenarios a user may wish to select the same image multiple times. In addition, typically only added images can be edited in the edit interface, losing the ability to edit previously selected images. This greatly reduces the user experience.

The embodiment of the invention provides a solution for interface interaction. According to various embodiments of the present disclosure, if the user wants to add the media content when displaying the post interface, the content interface is displayed, and the selected media content presented in the post interface is in an unselected state in the content interface. After receiving the selection of the added media content, the edit interface is displayed, and the edit interface supports an editing function for the previously selected media content and the added media content.

In the embodiments of the present disclosure, Media Content can be repeatedly selected, thereby enhancing the flexibility of content selection. Both the previously selected media content and the added media content can be edited, thereby enhancing the comprehensiveness of the content editing. In this way, the user experience of releasing Media Content can be improved.

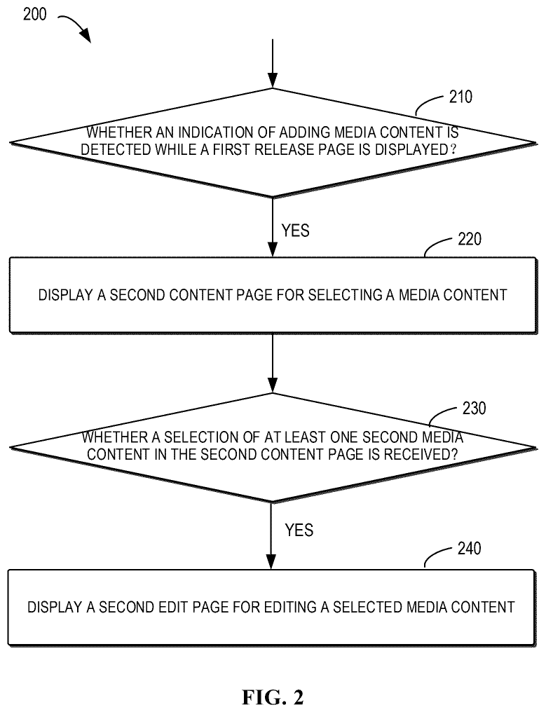

FIG. 2 illustrates a flowchart of a process 200 for interface interaction according to some embodiments of the present disclosure. The process 200 may be implemented at the terminal device 110. For ease of discussion, the process 200 will be described with reference to the environment 100 of FIG. 1.

At block 210, the terminal device 110 determines whether an indication of adding media content is detected while a first post interface is displayed. In the first post interface, at least one first media content that has been selected to be posted is presented. In some embodiments, the first media content that has been selected to be posted may be the same type of media content, such as an image. In other embodiments, the first media content may include different types of media content, such as images and videos.

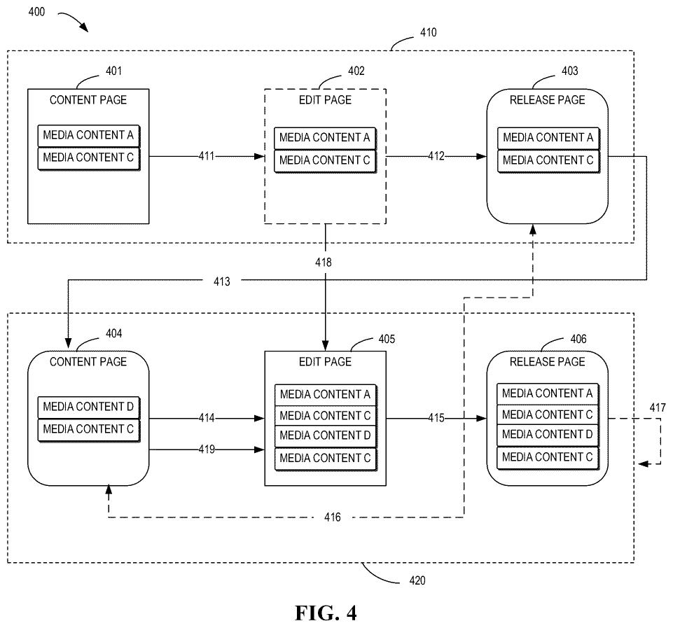

According to a media content post process, a first content interface and a first edit interface for editing the first media content may have been displayed prior to the first post interface being displayed. A first content interface (also referred to as a “benchmark content interface”) is a content interface that is first displayed based on a launch operation of the media content generation, as will be described below with reference to FIG. 4.

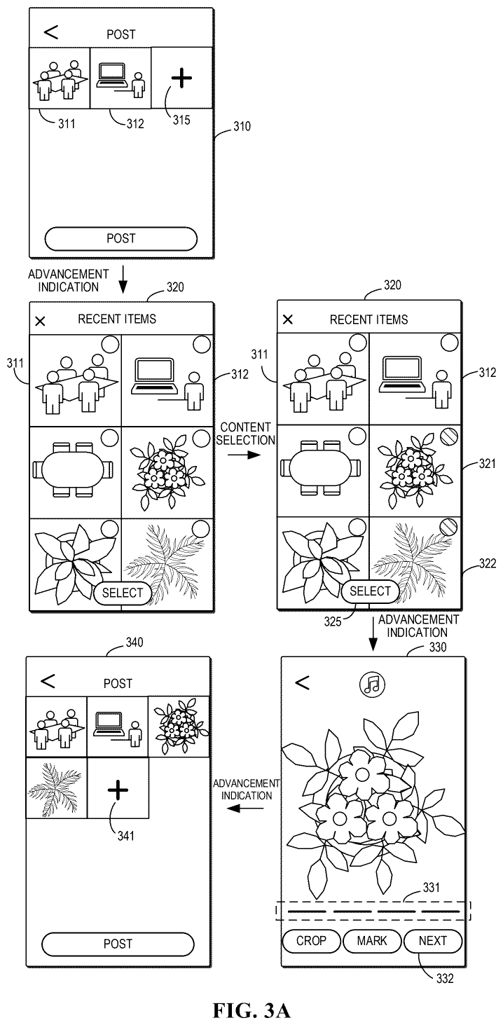

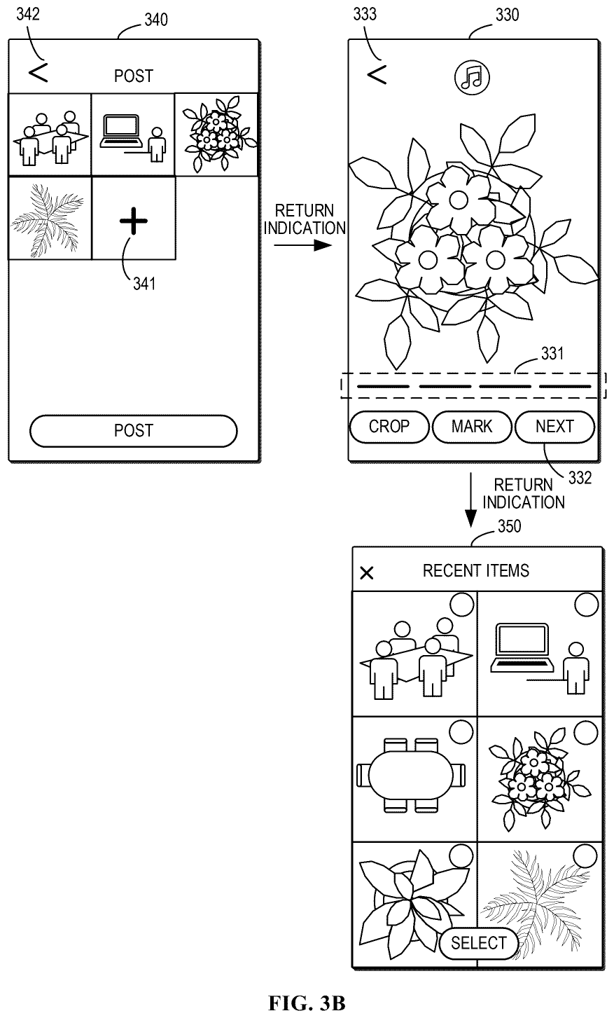

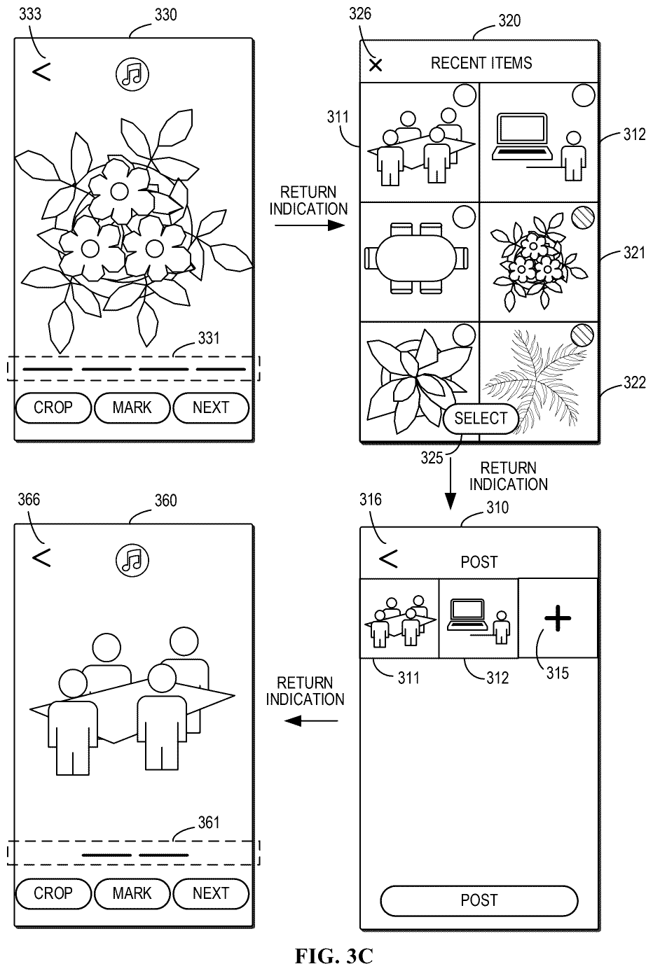

FIG. 3A illustrates a schematic diagram of an example interface change of an added media content according to some embodiments of the present disclosure. In the example of FIG. 3A, a first post interface 310 is displayed. A media content 311 and a media content 312 that have been selected to be posted are presented in the first post interface 310. The user 140 may provide an indication of an added media content by clicking an adding a media content icon 315. Correspondingly, the terminal device 110 may detect the indication of adding media content by determining whether the icon 315 is clicked.

It should be understood that interfaces 310, 320, 330, and 340 in FIG. 3A are merely example interface, and various interface designs may actually exist. Individual graphical elements in a interface, such as various icons, may have different arrangements and different visual representations, one or more of which may be omitted or replaced, and one or more other elements may also be exist. Embodiments of the present disclosure are not limited in this respect. In addition, an example of the image as the media content is shown in FIGS. 3A and 3B and 3C described below. It should be understood that this is merely example and is not intended to limit the scope of the present disclosure. Embodiments of the present disclosure are applicable to any suitable type of media content, such as images, videos, audio, and combinations thereof.

Reference is continued to FIG. 2. If an indication of adding media content is detected while the first post interface is displayed, the process 200 proceeds to block 220. At block 220, the terminal device 110 displays a second content interface for selecting media content. The previously selected at least one first media content is in an unselected state in the second content interface. In other words, the content interface displayed in response to the added media content supports the repeated selection of the media content. Therefore, the user may repeatedly select the media content according to requirements.

In the example of FIG. 3A, if the user 140 clicks on the adding a media content icon 315, the first post interface 310 is switched to the second content interface 320. In this example, the second content interface 320 is an album interface. In the second content interface 320, the previously selected media content 311 and the media content 312 are identified with a hollow circle icon. This means that media content 311 and media content 312 are in an unselected state and are instead selectable.

In some scenarios, a user may wish to present the same media content at different locations to implement, for example, an overall effect of Media Content Display. Therefore, providing repeated selection of media content can improve the flexibility of media content selection and meet the potential requirements of users.

At block 230, the terminal device 110 determines whether a selection of at least one second media content in the second content interface is received. If the selection of at least one second media content in the second content interface is received, the process 200 proceeds to block 240. At block 240, the terminal device 110 displays a second edit interface for editing the selected media content. The second edit interface supports an editing function for the at least one first media content and the at least one second media content. In other words, the second edit interface supports an editing function for all selected media content. Through the second edit interface, both the previously selected media content to be posted and the added media content can be edited, which is also referred to as the full editing of the media content.

In the example of FIG. 3A, through the second content interface 320, the user 140 selects a media content 321 and a media content 322. The displayed second content interface 320 is updated in response to a content selection from the user. In the updated second content interface 320, the media content 321 and the media content 322 are in the selected state. In response to detecting that the “selected” icon 325 is clicked in the updated second content interface 320, the second content interface 320 is switched to a second edit interface 330. In the current display of the second edit interface 330, the media content 321 is presented so that the media content 321 can be edited. The second edit interface 330 supports an editing function for all selected media content. For example, via a sliding icon 331 presented in the edit interface 330, it is possible to select which of all of the selected media content 311, 312, 321, and 322 to edit. It should be understood that the icon 331 shown in FIG. 3A is merely an example and are not intended to limit the scope of the present disclosure. In embodiments of the present disclosure, full editing may be accomplished in any suitable manner.

In some other scenarios, the user 140 may further select the media content 311 and the media content 312 through the second content interface 320, in this case, after switching from the second content interface 320 to the second edit interface 330, the second edit interface 330 will support editing functions for the first selected media content 311, 312 and the re-selected media content 311, 312, and the content displayed on a second post interface 340 will include two media content 311 and two media content 312.

In some scenarios, users may not only need to edit added media content but may also wish to make further edits to media content that has previously been selected for post. Thus, support for full editing may improve the comprehensiveness of image editing. In embodiments of the present disclosure, providing repeated selection and full editing of media content may improve the experience of the user during the media content post process.

Since the second content interface supports repeated selection of media content, in some embodiments, some of the media content in the at least one first media content and the at least one second media content may be the same media content. In such embodiments, the second edit interface providing full editing includes two instances of that same media content, and different edits can be made to the two instances.

In some embodiments, the second edit interface may be displayed in a manner that saves memory overhead. Specifically, the terminal device 110 may retrieve a cached instance of a first edit interface, the cached instance of the first edit interface being generated prior to the first post interface and comprising first information about the at least one first media content. The terminal device 110 may add second information about the at least one second media content to the cached instance of the first edit interface to generate a cached instance of the second edit interface and display the second edit interface based on the cached instance of the second edit interface. As used in this specification, the term “cached instance” refers to a interface version stored in a memory of a terminal device and may also be referred to simply as an “instance”.

In some embodiments, individual interface may be stored in a target stack. The storage location of the cached instance of the second edit interface in the target stack is located after the storage location of the cached instance of the second content interface in the target stack.

In such an embodiment, only one edit interface exists in the memory of the terminal device 110 at the same time. The edit interface usually occupies a large space due to the introduction of a complex editing function. In this way, memory consumption can be greatly reduced. Such embodiments will be described below with reference to FIG. 4.

The process 200 may include additional blocks or steps in addition to blocks 210, 220, 230, and 240. In some embodiments, if the advancement indication is detected while the second edit interface is displayed, the terminal device 110 may display the second post interface. At least one first media content and at least one second media content to be posted are presented in the second post interface. This advancement indication may be given in any suitable manner, embodiments of the present disclosure are not limited in this respect. In embodiments where the first media content and the second media content have the same media content, the second post interface presents two instances of the media content.

In some embodiments, in response to the second post interface being displayed, the terminal device 110 may remove a cached instance of the first posted interface and a cached instance of the second content interface from a target stack. In this way, memory consumption may be conserved.

In the example of FIG. 3A, if the media content editing has been completed or media content editing is not required, the user 140 may click the “Next” icon 332. In response to the icon 332 being clicked, the terminal device 110 displays the second post interface 340. The second post interface 340 presents all of the selected media content 311, 312, 321, and 322.

After displaying the second post interface, the user 140 may expect to back to a previous interface for re-operation. In some embodiments, if the interface back indication is detected while the second post interface is displayed, the terminal device 110 displays the second edit interface. That is, in response to detecting an indication to back from the second post interface, the second post interface is switched back to the second edit interface.

If the interface back indication is detected while the second edit interface is displayed, the terminal device 110 determines whether an instance of the first post interface exists in the target stack. As instances of the first post interface and the second content interface are removed when entering the second post interface, the terminal device 110 determines that the instance of the first post interface is lacked. Correspondingly, the terminal device 110 displays the benchmark content interface, that is, the content interface that is displayed for the first time in response to the trigger of the content releasing process.

In embodiments of the present disclosure, the interface back indication may be provided by a back icon presented on a interface, by a gesture by the user 140, or by any other suitable manner. Embodiments of the present disclosure are not limited in this respect.

FIG. 3B illustrates a schematic diagram of an example interface change of falling back from the second post interface 340 according to some embodiments of the present disclosure. In the example of FIG. 3B, the user 140 may click a back icon 342 while the second post interface 340 is displayed. In response to detecting that the back icon 342 is clicked, the terminal device 110 displays the second edit interface 330. While the second edit interface 330 is displayed, the user 140 may click a back icon 333. In response to detecting that the back icon 333 is clicked, the terminal device 110 displays a benchmark content interface 350.

As can be seen from the above description, in the case of entering the second post interface from the second edit interface, it is possible to return from the second post interface to the benchmark content interface through the second edit interface.

In some scenarios, where the second edit interface is displayed without entering the second post interface, the user 140 may expect to fall back to one of the previous interfaces. In some embodiments, if a interface back indication is detected while the second edit interface is being displayed, the terminal device 110 may determine whether an instance of the first post interface exists in the target stack. Since the second post interface has not been entered, the instances of the first post interface and the second content interface have not been removed, and the terminal device 110 determines that an instance of the first post interface exists. Accordingly, the terminal device 110 may display the second content interface. Returning to the second content interface, the user 140 may reselect the second media content.

Further, if the interface back indication is detected while the second content interface is displayed, the terminal device 110 may display the first post interface. Returning to the first post interface, the user 140 may post a previously selected media content.

Further, if the interface back indication is detected while the first post interface is displayed, the terminal device 110 may display the first edit interface. Different from the second edit interface, the first edit interface supports an editing function that has been selected as the media content to be posted prior to the second content interface is first displayed. Therefore, the first edit interface supports an editing function on the first media content and does not support an editing function on the second media content.

Similar to the display of the second edit interface, in some embodiments, the first edit interface may be switched back in a manner of saving memory consumption. Specifically, the terminal device 110 may retrieve a cached instance of the second edit interface, the cached instance of the second edit interface comprising first information about the at least one first media content and second information about the at least one second media content. The terminal device 110 may generate the second information from the cached instance of the second edit interface to generate a cached instance of the first edit interface and display the first edit interface based on the cached instance.

In some embodiments, individual interface may be stored in a target stack. The storage location of the cached instance of the first edit interface in the target stack is before the storage location of the cached instance of the first post interface in the target stack.

Further, if the interface back indication is detected while the first edit interface is displayed, the terminal device 110 may display the benchmark content interface.

FIG. 3C illustrates a schematic diagram of an example interface change of falling back from the second edit interface 330 according to some embodiments of the present disclosure. While the edit interface 330 is displayed, the user 140 does not give an advancement indication from the edit interface 330, but rather gives a back indication. For example, the user 140 clicks the back icon 333. In response to detecting that the back icon 333 is clicked, the terminal device 110 displays the second content interface 320. While the second content interface 320 is displayed, the user 140 may click a discard icon 326 or make a back gesture, giving a back indication. In response to detecting a back indication, the terminal device 110 displays the first post interface 310.

While the first post interface 310 is displayed, the user 140 may click a back icon 316. In response to detecting that the back icon 316 is clicked, the terminal device 110 displays the first edit interface 360. The first edit interface 360 supports an editing function for previously selected media content 311 and 312 without providing an editing function for media content 321 and 322. By sliding the icon 331, the user 140 may select which of the media content 311 and 312 to edit.

Still further, the user 140 may click a back icon 366 while the first edit interface 360 is displayed. In response to detecting that the back icon 366 is clicked, the terminal device 110 displays the benchmark content interface 350 shown in FIG. 3B.

As can be seen from the above description, it is possible to fall back from the second edit interface through the second content interface and the first post interface to the first edit interface without entering the second post interface. It is further possible to fall back from the first edit interface to the benchmark content interface.

Changes in the interface displayed in the media content post flow are described above with reference to FIGS. 3A to 3C. Example underlying operations and memory occupancy in the media content post and return flow are described below.

FIG. 4 illustrates a schematic diagram of a forward flow 400 of media content post according to some embodiments of the present disclosure. The forward flow 400 further includes a normal flow 410 and an added flow 420.

In the normal flow 410, the terminal device 110 displays a content interface 401 based on a launch operation of a media content generation (e.g., post). For example, the user clicks an album icon in the application 120 to trigger the media content post process. The terminal device 110 creates and displays the content interface 401 accordingly. It can be understood that the content interface 401 is an example of the first content interface, or the benchmark content interface mentioned above.

In the example of FIG. 4, the user 140 selects Media Content A and Media Content C and clicks on the “select” icon. In response to receiving the selection of media contents in the content interface 401, the terminal device 110 creates (411) and displays an edit interface 402. The edit interface 402 supports an editing function for Media Content A and Media Content C.

If an advancement indication is detected while the edit interface 402 is displayed, such as the user 140 clicking on a next icon, the terminal device 110 creates (412) and displays a post interface 403. The post interface 403 is presented with Media Content A and Media Content C. If an indication of adding media content is detected while the post interface 403 is displayed, for example, the user 104 clicks the adding a media content icon, the flow 400 enters to a added process 420. The terminal device 110 creates (413) and displays a content interface 404.

In the example of FIG. 4, the user 140 selects Media Content C and Media Content D in the content interface 404 and clicks on the “select” icon. In this example, Media Content C is again selected. In response to receiving the selection of the media content in the content interface 404, the terminal device 110 retrieves (418) an instance of the edit interface 402 from the stack. Instances of the edit interface 402 include data of Media Content A and Media Content C. The terminal device 110 adds (419) the data of Media Content C and Media Content D into the instance of the edit interface 402, thus obtaining an instance of the edit interface 405. In the stack, an instance of the edit interface 405 is stored (414) after the instance of the content interface 404. As shown in FIG. 4, the edit interface 405 supports an editing function for the previously selected Media Content A and Media Content C as well as the added Media Content C and Media Content D.

If an advancement indication is detected while edit interface 405 is displayed, e.g., user 140 clicks on the “Next” icon, terminal device 110 creates (415) and displays a post interface 406. The post interface 406 presents Media Content A and Media Content C selected in the normal flow 410 and Media Content C and Media Content D selected in the added flow 420. Accordingly, the terminal device 110 removes (416) instances of the post interface 403 and the content interface 404 from the stack.

If the indication of adding media content is detected while the post interface 406 is displayed, the process similar to the added flow 420 is repeated (417).

Table 1 summarizes events, operations, and memory occupancy of the example flow 400. As shown in Table 1, in the forward flow of media content post, there are at most one edit interface, two content interfaces and one post interface in the memory. Compared with the cited documents, in conventional solutions, an added content interface, an edit interface and a post interface are generated in each process of adding the media content, and the previous content interface, the edit interface and the post interface are not multiplexed or deleted, and a large amount of memory can be consumed or even flash. Therefore, the memory consumption can be greatly reduced in the flow 400, and a smoother operation experience is provided for the user.

TABLE 1
Events, Operations, and Memory Occupancy for Media Content Post Forward Flow

| | Event | Operation | Memory Occupancy |
|---|---|---|---|
| Normal | Launch media content | Create and display the content | [the content interface |
| Flow | generation | interface 401 | 401] |
| | Receive a selection of | Create and display the edit | [the content interface |
| | media content | interface 402 | 401, the edit interface |
| | | | 402] |
| | Detect an advancement | Create and display the post | [the content interface |
| | indication from the edit | interface 403 | 401, the edit interface |
| | interface 402 | | 402, the post interface |
| | | | 403] |
| New | Detect an indication of | Create and display the content | [the content interface |
| Flow | adding media content | interface 404 | 401, the edit interface |
| | | | 402, the post interface |
| | | | 403 the content |
| | | | interface 404] |
| | Receive a selection of | Retrieve instance of the edit | [the content interface |
| | media content | interface 402 | 401, the post interface |
| | | Add information of the added | 403 the content |
| | | media content to generate an | interface 404, the edit |
| | | instance of the edit interface | interface 405] |
| | | 405 | |
| | | Store an instance of the edit | |
| | | interface 405 after an instance | |
| | | of the content interface 404 | |
| | Detect an advancement | Create and display the post | [the content interface |
| | indication from the edit | interface 406 | 401, the edit interface |
| | interface 405 | Remove an instance of the post | 405 the post interface |
| | | interface 403 | 406] |
| | | Remove an instance of the | |
| | | content interface 404 | |
| | Detect an indication of | Create and display a next | [the content interface |
| | adding media content | content interface | 401, the edit interface |
| | | | 405 the post interface |
| | | | 406, the next content |
| | | | interface] |

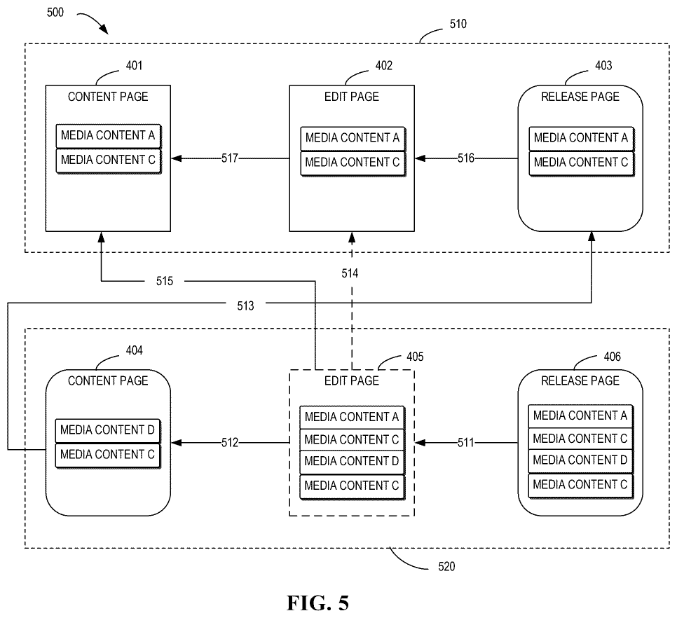

FIG. 5 illustrates a schematic diagram of a return flow 500 of media content post according to some embodiments of the present disclosure. Corresponding to the flow 400, the flow 500 may further include a normal flow 510 and an added flow 520.

In the added flow 520, a back indication is detected while the post interface 406 is displayed. As an instance of the edit interface 405 is stored in the stack, it returns normally to the edit interface 405. The terminal device 110 displays (511) the edit interface 405.

A back indication is detected while the edit interface 405 is displayed. The terminal device 110 determines whether an instance of the post interface 403 exits in the stack. That is, the terminal device 110 determines whether to display the post interface 406. It may be understood that, since there is at most one instance of a post interface in the memory, the terminal device 110 may determine whether a post interface exits in the stack.

If the target stack lacks instance of the post interface 403, i.e., when the post interface 406 is displayed, the terminal device 110 dismisses the stack and displays (515) the content interface 401. The content interface 401 is a benchmark content interface in this example.

If an instance of the post interface 403 exits in the stack, i.e., without displaying the post interface 406, it returns normally to the content interface 404. The terminal device 110 displays (512) the content interface 404. Meanwhile, the terminal device 110 removes the data of Media Content C and Media Content D from the instance of the edit interface 405 to generate an instance of the edit interface 402. In the stack, the terminal device 110 stores (514) the instance of the edit interface 402 before the instance of the post interface 403.

If a interface back indication is detected while the content interface 404 is displayed, it returns normally to the post interface 403. The terminal device 110 displays (513) the post interface 403. If a interface back indication is detected while the post interface 403 is being displayed, it returns normally to the edit interface 402. The terminal device 110 displays (516) the edit interface 402.

If a interface back indication is detected while the edit interface 402 is displayed, it returns normally to the content interface 401. The terminal device 110 displays (517) the content interface 401. If a interface back indication is detected while the content interface 401 is displayed, the content interface 401 is discarded. The terminal device 110 may then display a trigger interface or a preparation interface of the media content post process.

Table 2 summarizes the events, operations, and memory occupancy of the example flow 500. As shown in Table 2, in the return flow of media content post, there are at most one edit interface, two content interfaces and one post interface in the memory. Therefore, the memory consumption can be greatly reduced in the flow 500, and a smoother operation experience is provided for the user.

TABLE 2
Events, Operations, and Memory Occupancy for Media Content Post Return Flow

| | Event | Operation | Memory Occupancy |
|---|---|---|---|
| New | Detect an indication to | Return normally to the edit | [the content interface |
| Flow | back from the post | interface 405 | 401, the edit interface |
| | interface 406 | | 405 the post interface |
| | | | 406] |
| | Detect an indication to | If an instance of the post interface | [the content interface |
| | back from the edit | exists in the stack (i.e., the post | 401, the edit interface |
| | interface 405 | interface 406 is not shown). | 402, the post interface |
| | | Return normally to the | 403 the content |
| | | content interface 404 | interface 404] |
| | | An instance of the edit | |
| | | interface 402 is generated | |
| | | based on the instance of the | |
| | | edit interface 405 and stored | |
| | | before the post interface 403. | |
| | | If the stack lacks the instance of | [the content interface |
| | | the post interface (i.e., the post | 401] |
| | | interface 406 is displayed) | |
| | | Return to the content | |
| | | interface 401 | |
| | Detect an indication to | Return normally to the post | [the content interface |
| | back from the content | interface 403 | 401, the edit interface |
| | interface 404 | | 402, the post interface |
| | | | 403] |
| New | Detect an indication to | Return normally to the edit | [the content interface |
| Flow | back from the post | interface 402 | 401, the edit interface |
| | interface 403 | | 402] |
| | Detect an indication to | Return normally to the | [the content interface |
| | back from the edit | content interface 401 | 401] |
| | interface 402 | | |
| | Detect an indication to | Discard a display of the | [ ] |
| | back from the content | content interface 401 | |
| | interface 401 | | |

In the example of FIGS. 4 and 5, the post interface 403 is an example of a first post interface, the content interface 404 is an example of a second content interface, the edit interface 405 is an example of a second edit interface, and the post interface 406 is an example of a second post interface. However, it should be understood that for the added flow after the flow 400, the post interface 406 may act as the first post interface.

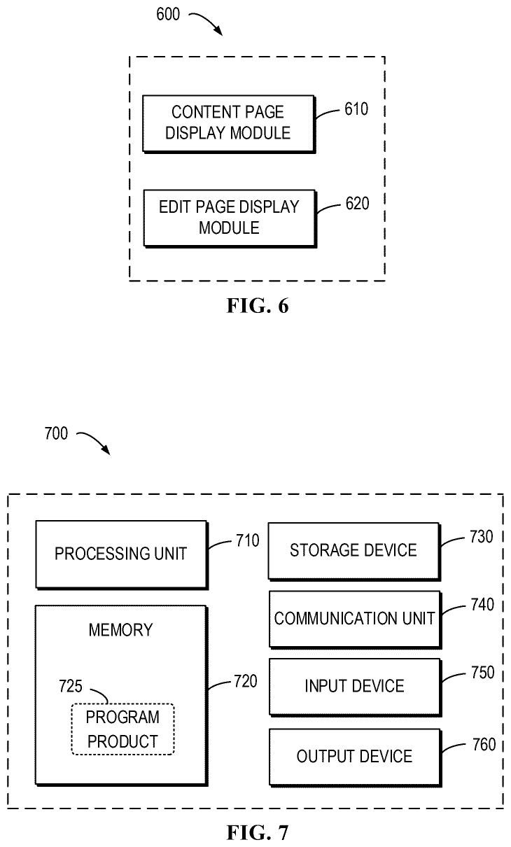

FIG. 6 is a schematic structural block diagram of an apparatus 600 for interface interaction according to some embodiments of the present disclosure. The apparatus 600 may be implemented or included in the terminal device 110. The various modules/components in the apparatus 600 may be implemented by hardware, software, firmware, or any combination thereof.

As shown, the apparatus 600 includes a content interface display module 610 configured to, in response to detecting an indication of adding media content while a first post interface is displayed, display a second content interface for selecting a media content, the first post interface presenting at least one first media content that has been selected to be posted, the at least one first media content being in an unselected state in the second content interface. The apparatus 600 further includes an edit interface display module 620 configured to, in response to receiving a selection of at least one second media content in the second content interface, display a second edit interface for editing a selected media content, the second edit interface providing an editing function for the at least one first media content and the at least one second media content.

In some embodiments, at least part of media contents in the at least one first media content and the at least one second media content are the same media content.

In some embodiments, the edit interface display module 620 includes: a first instance retrieval module configured to retrieve a cached instance of a first edit interface for editing a selected media content, the cached instance of the first edit interface being generated prior to the first post interface and comprising first information about the at least one first media content; an information addition module configured to add second information about the at least one second media content to the cached instance of the first edit interface to generate a cached instance of the second edit interface; and a first instance display module configured to display the second edit interface based on the cached instance of the second edit interface.

In some embodiments, the cached instance of the second edit interface is stored in a first storage location in a target stack, and the first storage location is located after a second storage location of the cached instance of the second content interface in the target stack.

In some embodiments, the apparatus 600 further includes: a first back module configured to, in response to detecting a first interface back indication while the second edit interface is displayed, display the second content interface; a second back module configured to, in response to detecting a second interface back indication while the second content interface is displayed, display the first post interface; and a third back module configured to, in response to detecting a third interface back indication while the first post interface is displayed, display a first edit interface providing an editing function for a media content that has been selected to be posted prior to the second content interface being displayed for the first time.

In some embodiments, the third back module includes: a second instance retrieval module configured to retrieve a cached instance of the second edit interface, the cached instance of the second edit interface comprising first information about the at least one first media content and second information about the at least one second media content; an information removal module configured to remove the second information from the cached instance of the second edit interface to generate a cached instance of the first edit interface; and a second instance display module configured to display the first edit interface based on the cached instance of the first edit interface.

In some embodiments, the cached instance of the first edit interface is stored in a third storage location in a target stack, and the third storage location is located before a fourth storage location of a cached instance of the first post interface in the target stack.

In some embodiments, the apparatus 600 further includes an instance removal module configured to, in response to the second post interface being displayed, remove a cached instance of the first posted interface and a cached instance of the second content interface from a target stack.

In some embodiments, the apparatus 600 further includes: a fourth back module configured to, in response to detecting a fourth interface back indication while a second post interface is displayed, display the second edit interface, the second post interface presenting the at least one first media content and the at least one second media content to be posted; and a fifth back module configured to, in response to detecting a fifth interface back indication while the second edit interface is displayed, display a first content interface that is a content interface displayed for the first time based on a launch operation generated by a media content.

In some embodiments, the fifth back module is further configured to: in response to detecting a fifth interface back indication, determining whether the cached instance of the first post interface presents in the target stack; and in response to determining that the cached instance of the first post interface is absent from the target stack, displaying the first content interface.

FIG. 7 illustrates a block diagram illustrating a computing device 700 in which one or more embodiments of the present disclosure may be implemented. It should be understood that the computing device 700 shown in FIG. 7 is merely example and should not constitute any limitation on the functionality and scope of the embodiments described herein. The computing device 700 shown in FIG. 7 may be configured to implement the terminal device 110 in FIG. 1.

As shown in FIG. 7, the computing device 700 is in the form of a general-purpose computing device. Components of the computing device 700 may include, but are not limited to, one or more processors or processing units 710, a memory 720, a storage device 730, one or more communication units 740, one or more input devices 750, and one or more output devices 760. The processing unit 710 may be an actual or virtual processor and capable of performing various processes according to programs stored in the memory 720. In multiprocessor system, a plurality of processing units execute computer-executable indications in parallel to improve parallel processing capabilities of the computing device 700.

The computing device 700 typically includes a plurality of computer storage media. Such media may be any available media accessible by the computing device 700, including, but not limited to, volatile and non-volatile media, removable and non-removable media. The memory 720 may be a volatile memory (e.g., register, cache, random access memory (RAM)), a non-volatile memory (e.g., read-only memory (ROM), electrically erasable programmable read-only memory (EEPROM), flash memory), or some combination thereof. The storage device 730 may be a removable or non-removable medium and may include a machine-readable medium, such as a flash drive, magnetic disk, or any other medium, which may be capable of storing information and/or data (e.g., training data for training) and may be accessed within the computing device 700.

The computing device 700 may further include additional removable/non-removable, volatile/non-volatile storage media. Although not shown in FIG. 7, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interface. The memory 720 may include a computer program product 725 having one or more program modules configured to perform various methods or actions of various embodiments of the present disclosure.

The communication unit 740 implements communications with other computing devices over a communication medium. Additionally, the functionality of components of the computing device 700 may be implemented in a single computing cluster or multiple computing machines capable of communicating over a communication connection. Thus, the computing device 700 may operate in a networked environment using logical connections with one or more other servers, network personal computers (PCs), or another network node.

The input device 750 may be one or more input devices, such as a mouse, a keyboard, a trackball, or the like. The output device 760 may be one or more output devices, such as a display, a speaker, a printer, or the like. The computing device 700 may also communicate with one or more external devices (not shown) as needed, external devices such as storage devices, display devices, etc., communicate with one or more devices that enable a user to interact with the computing device 700, or communicate with any device (e.g., network card, modem, etc.) that enables the computing device 700 to communicate with one or more other computing devices. Such communication may be performed via an input/output (I/O) interface (not shown).

According to example implementations of the present disclosure, a computer-readable storage medium having computer-executable indications stored thereon is provided, wherein the computer-executable indications are executed by a processor to implement the method described above. According to example implementations of the present disclosure, a computer program product is further provided, the computer program product being tangibly stored on a non-transitory computer-readable medium and including computer-executable indications, the computer-executable indications being executed by a processor to implement the method described above.

Aspects of the present disclosure are described herein with reference to flowcharts and/or block diagrams of a method, an apparatus, a device, and computer program product implemented in accordance with the present disclosure. It should be understood that each block of the flowchart and/or block diagram, and combinations of blocks in the flowcharts and/or block diagrams, may be implemented by computer readable program indications.

These computer-readable program indications may be provided to a processing unit of a general purpose computer, special purpose computer, or other programmable data processing apparatus to produce a machine, such that the indications, when executed by a processing unit of a computer or other programmable data processing apparatus, produce an apparatus to implement the functions/acts specified in the flowchart and/or block diagram. These computer-readable program indications may also be stored in a computer-readable storage medium that cause the computer, programmable data processing apparatus, and/or other devices to function in a particular manner, such that the computer-readable medium storing indications includes an article of manufacture including indications to implement aspects of the functions/acts specified in the flowchart and/or block diagram (s).

The computer-readable program indications may be loaded onto a computer, other programmable data processing apparatus, or other devices, such that a series of operational steps are performed on a computer, other programmable data processing apparatus, or other devices to produce a computer-implemented process such that the indications executed on a computer, other programmable data processing apparatus, or other devices implement the functions/acts specified in the flowchart and/or block diagram block or blocks.

The flowchart and block diagrams in the figures show architecture, functionality, and operation of possible implementations of systems, methods, and computer program products according to various implementations of the present disclosure. In this regard, each block in the flowchart or block diagram may represent a module, program segment, or portion of an indication that includes one or more executable indications for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer indications.

Various implementations of the present disclosure have been described above, which are exemplary, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed in this specification.

1-20. (canceled)

21. A method of interface interaction, comprising:
in response to detecting an indication of adding media content while a first post interface is displayed, displaying a second content interface for selecting a media content, the first post interface presenting at least one first media content that has been selected to be posted, the at least one first media content being in an unselected state in the second content interface; and
in response to receiving a selection of at least one second media content in the second content interface, displaying a second edit interface for editing a selected media content, the second edit interface providing an editing function for the at least one first media content and the at least one second media content.

22. The method of claim 21, further comprising:
in response to detecting a first interface back indication while the second edit interface is displayed, displaying the second content interface;
in response to detecting a second interface back indication while the second content interface is displayed, displaying the first post interface; and
in response to detecting a third interface back indication while the first post interface is displayed, displaying a first edit interface providing an editing function for a media content that has been selected to be post prior to the second content interface being displayed for the first time.

23. The method of claim 21, further comprising:
in response to detecting a fourth interface back indication while a second post interface is displayed, displaying the second edit interface, the second post interface presenting the at least one first media content and the at least one second media content to be posted; and
in response to detecting a fifth interface back indication while the second edit interface is displayed, displaying a first content interface that is a content interface displayed for the first time based on a launch operation generated by a media content.

24. The method of claim 21, wherein displaying the second edit interface comprises:
retrieving a cached instance of a first edit interface for editing a selected media content, the cached instance of the first edit interface being generated prior to the first post interface and comprising first information about the at least one first media content;
adding second information about the at least one second media content to the cached instance of the first edit interface to generate a cached instance of the second edit interface; and
displaying the second edit interface based on the cached instance of the second edit interface.

25. The method of claim 24, wherein the cached instance of the second edit interface is stored in a first storage location in a target stack, and the first storage location is located after a second storage location of the cached instance of the second content interface in the target stack.

26. The method of claim 22, wherein displaying the first edit interface comprises:
retrieving a cached instance of the second edit interface, the cached instance of the second edit interface comprising first information about the at least one first media content and second information about the at least one second media content;
removing the second information from the cached instance of the second edit interface to generate a cached instance of the first edit interface; and
displaying the first edit interface based on the cached instance of the first edit interface.

27. The method of claim 26, wherein the cached instance of the first edit interface is stored in a third storage location in a target stack, and the third storage location is located before a fourth storage location of a cached instance of the first post interface in the target stack.

28. The method of claim 23, further comprising:
in response to the second post interface being displayed, removing a cached instance of the first post interface and a cached instance of the second content interface from a target stack.

29. The method of claim 28, wherein displaying the first content interface comprises:
in response to detecting a fifth interface back indication, determining whether the cached instance of the first post interface presents in the target stack; and
in response to determining that the cached instance of the first post interface is absent from the target stack, displaying the first content interface.

30. The method of claim 21, wherein at least part of media contents in the at least one first media content and the at least one second media content are the same media content.

31. An electronic device, comprising:
at least one processing unit; and
at least one memory coupled to the at least one processing unit and storing instructions for execution by the at least one processing unit, the instructions, when executed by the at least one processing unit, causing the electronic device to perform at least:
in response to detecting an indication of adding media content while a first post interface is displayed, displaying a second content interface for selecting a media content, the first post interface presenting at least one first media content that has been selected to be posted, the at least one first media content being in an unselected state in the second content interface; and
in response to receiving a selection of at least one second media content in the second content interface, displaying a second edit interface for editing a selected media content, the second edit interface providing an editing function for the at least one first media content and the at least one second media content.

32. The electronic device of claim 31, wherein the electronic device is further caused to perform:
in response to detecting a first interface back indication while the second edit interface is displayed, displaying the second content interface;
in response to detecting a second interface back indication while the second content interface is displayed, displaying the first post interface; and
in response to detecting a third interface back indication while the first post interface is displayed, displaying a first edit interface providing an editing function for a media content that has been selected to be posted prior to the second content interface being displayed for the first time.

33. The electronic device of claim 31, wherein the electronic device is further caused to perform:
in response to detecting a fourth interface back indication while a second post interface is displayed, displaying the second edit interface, the second post interface presenting the at least one first media content and the at least one second media content to be posted; and
in response to detecting a fifth interface back indication while the second edit interface is displayed, displaying a first content interface that is a content interface displayed for the first time based on a launch operation generated by a media content.

34. The electronic device of claim 31, wherein displaying the second edit interface comprises:
retrieving a cached instance of a first edit interface for editing a selected media content, the cached instance of the first edit interface being generated prior to the first post interface and comprising first information about the at least one first media content;
adding second information about the at least one second media content to the cached instance of the first edit interface to generate a cached instance of the second edit interface; and
displaying the second edit interface based on the cached instance of the second edit interface.

35. The electronic device of claim 34, wherein the cached instance of the second edit interface is stored in a first storage location in a target stack, and the first storage location is located after a second storage location of the cached instance of the second content interface in the target stack.

36. The electronic device of claim 32, wherein displaying the first edit interface comprises:
retrieving a cached instance of the second edit interface, the cached instance of the second edit interface comprising first information about the at least one first media content and second information about the at least one second media content;
removing the second information from the cached instance of the second edit interface to generate a cached instance of the first edit interface; and
displaying the first edit interface based on the cached instance of the first edit interface.

37. The electronic device claim 36, wherein the cached instance of the first edit interface is stored in a third storage location in a target stack, and the third storage location is located before a fourth storage location of a cached instance of the first post interface in the target stack.

38. The electronic device claim 33, wherein the acts further comprise:
in response to the second post interface being displayed, removing a cached instance of the first post interface and a cached instance of the second content interface from a target stack.

39. The electronic device claim 38, wherein displaying the first content interface comprises:
in response to detecting a fifth interface back indication, determining whether the cached instance of the first post interface presents in the target stack; and
in response to determining that the cached instance of the first post interface is absent from the target stack, displaying the first content interface.

40. A non-transitory computer-readable storage medium having a computer program stored thereon, the computer program being executable by a processor to implement at least:
in response to detecting an indication of adding media content while a first post interface is displayed, displaying a second content interface for selecting a media content, the first post interface presenting at least one first media content that has been selected to be posted, the at least one first media content being in an unselected state in the second content interface; and
in response to receiving a selection of at least one second media content in the second content interface, displaying a second edit interface for editing a selected media content, the second edit interface providing an editing function for the at least one first media content and the at least one second media content.
